(19) United States
(12) Patent Application Publication
(10) Pub. No.: US 2010/0284101 A1
(43) Pub. Date: Nov. 11, 2010

(54) LIGHT-ABSORBING MEMBER AND METHOD OF PRODUCING THE SAME

(75) Inventors: Kazuhiko Mori, Atsugi-shi (JP); Yasuhiro Okano, Isehara-shi (JP); Hiroki Hayashi, Kitakyushu-shi (JP)

Correspondence Address: HENKEL CORPORATION, One Henkel Way, ROCKY HILL, CT, 06067, US

(73) Assignee: Henkel AG & Co. KGaA, Duesseldorf (DE)

(21) Appl. No.: 12/758,389

(22) Filed: Apr. 12, 2010

Related U.S. Application Data
(63) Continuation of application No. PCT/JP2008/068569, filed on Oct. 14, 2008.

(30) Foreign Application Priority Data
Oct. 12, 2007 (JP) 2007-266786

(51) Int. Cl. G02B 5/22; B05D 5/06

(52) U.S. Cl. 359/885; 427/162

(57) ABSTRACT

The present invention relates to a light-absorbing member comprising a substrate having a zinc/aluminum surface, a black lower layer containing nickel and/or cobalt which is in contact with the surface and an upper layer containing an oxide of at least one selected from aluminum, magnesium, and zinc; and a method of producing the same.

### CROSS-REFERENCE TO RELATED APPLICATIONS

This application is a continuation under 35 U.S.C. Sections 365(c) and 120 of International Application No. PCT/JP2008/068569, filed Oct. 14, 2008 and published on Apr. 16, 2009 as WO 2009/048155, which claims priority from Japanese Patent Application No. 2007-266786 filed Oct. 12, 2007, which are incorporated herein by reference in their entirety.

### FIELD OF THE INVENTION

The present invention relates to a surface treating technique for a metal material such as a material having a zinc/aluminum surface, for example, a zinc/aluminum plating material, zinc plated aluminum, zinc/aluminum die cast, sheet, foil, and the like, and more particularly, to a light-absorbing member used for home electric appliances, kitchenware, parts of optical apparatuses, parts of transport equipment, parts of electronic apparatuses, building materials, or the like in order to perform a blackening process, to improve light absorption, or to prevent light reflection, and a method of producing the same.

### BACKGROUND OF THE INVENTION

Since a zinc substitution plated aluminum or zinc die cast, an electro-galvanized or hot-dip galvanized steel, an aluminum sheet, an aluminum radiator, a foil, an aluminized film, or the like has an outer appearance having a color of white, grayish white, silvery white, or the like, a blackening process for obtaining a high-grade, high-quality appearance, preventing light reflection, and preventing light glare is needed in many cases. By nature, since a metal surface has a metal gloss, the metal surface has high light reflectance. However, if fine metal particles having a size of light wavelength or less are precipitated on the metal surface through surface treatment, or if convex-concave portions are formed on the metal surface, the metal surface absorbs light, so that a black surface can be formed.

Conventionally, in order to achieve this object, techniques of substituting and precipitating fine metal particles on a zinc or zinc-plated surface have been known. As an example of the techniques, Patent Document 1 (Japanese Patent Application Laid-Open (JP-A) No. 61-253381) discloses a processing method using a blackening agent containing an oxidant and copper ions added with nickel ions. In addition, Patent Document 2 (Japanese Patent Application Laid-Open (JP-A) No. 2-47273) discloses a processing method using an alkali aqueous solution containing Ni²⁺ of 1 g/L or more and ammonia of 6-fold moles or more and having a pH less than pH 11. In addition, as an example of an aluminum blackening process technique, Patent Document 3 (Japanese Patent Application Laid-Open (JP-A) No. 63-86873) discloses a processing method using a solution containing copper or silver ions that are subjected to a zinc substitution process, or Patent Document 4 (Japanese Patent Application Laid-Open (JP-A) No. 63-60290) discloses a processing method using a solution containing zinc and antimony. However, in these methods, there are problems in that expensive silver is used and in that work environment is harmful due to a noxious water-soluble antimony compound and a malodor of ammonia in the agent. In addition, since coated-film adhesion is not sufficient, the precipitated black particles are abraded and detached, so that clothes may be contaminated.

On the other hand, Patent Document 5 (Japanese Patent Application Laid-Open (JP-A) No. 2005-187838) discloses a method of forming a blackening reaction layer by processing a surface made of zinc or a zinc alloy by using an aqueous solution containing metal ions of at least one of nickel and cobalt and a sulfur-containing compound. Other published patent documents: Patent Document 1: Japanese Patent Application Laid-Open (JP-A) No. 61-253381; Patent Document 2: Japanese Patent Application Laid-Open (JP-A) No. 2-47273; Patent Document 3: Japanese Patent Application Laid-Open (JP-A) No. 63-86873; Patent Document 4: Japanese Patent Application lid-Open (JP-A) No. 63-60290; and Patent Document 5: Japanese Patent Application Laid-Open (JP-A) No. 2005-187838

### SUMMARY OF THE INVENTION

The present invention is to provide a light-absorbing member having a light-absorbing layer, which has a high black chromaticity, of which the black layer is not easily detached, and which has an excellent coated film adhesion, formed on a metal material surface having a surface made of a zinc and/or aluminum alloy and a method of producing the light-absorbing member.

The inventor has contrived a light-absorbing member, which has a high black chromaticity, of which the black layer is not easily detached, and which has an excellent coated film adhesion, formed on a metal material having a surface made of zinc and/or aluminum and a method of producing the light-absorbing member and invented the following configurations.

In other words, a light-absorbing member according to the present invention includes a black lower layer containing nickel and/or cobalt which is in contact with a surface of a to-be-processed substrate, which contains zinc and/or aluminum, and an upper layer containing an oxide of at least one selected from aluminum, magnesium, and zinc.

A first method of producing a light-absorbing member according to the present invention is a method of producing the light-absorbing member having the above configuration. In the method, the to-be-processed substrate having the to-be-processed surface containing zinc and/or aluminum is allowed to be in contact with an aqueous solution containing nickel ions and/or cobalt ions, a water-soluble sulfur-containing compound, and acidic anions, so that the black lower layer containing nickel and/or cobalt is formed on the to-be-processed surface, and after that, the upper layer containing an oxide of at least one selected from aluminum, magnesium, and zinc is formed on the lower layer.

A second method of producing a light-absorbing member according to the present invention is a method of producing the light-absorbing member having the above configuration. In the method, the to-be-processed substrate having the to-be-processed surface containing zinc and/or aluminum is allowed to be in contact with an aqueous solution containing at least one selected from aluminum, magnesium, and zinc, nickel ions and/or cobalt ions, a water-soluble sulfur-containing compound, and acidic anions, so that the black lower layer containing nickel and/or cobalt and the upper layer containing an oxide of at least one selected from aluminum, magnesium, and zinc are simultaneously formed.

In a third producing method according to the present invention, the acidic anions include fluoride ions. In a fourth producing method, the water-soluble sulfur-containing compound has a C═S bond and a —NH₂ group in a structure thereof. In a fifth producing method, the water-soluble sulfur-containing compound is at least one selected from thiourea dioxide, thiourea, and a derivative thereof.

In addition, in a sixth producing method, a concentration ratio (A)/(B) of a concentration (A g/L) of zinc in the aqueous solution to a concentration (B g/L) of nickel ions and/or cobalt ions is in a range of 0.05 to 1.0.

According to the invention, the upper layer containing an oxide of at least one selected from aluminum, magnesium, and zinc is formed on the black lower layer containing nickel and/or cobalt, so that a light-absorbing layer which has a high black chromaticity, of which the black layer is not easily detached, and which has an excellent coated film adhesion can be formed on the surface of the to-be-processed substrate, which contains zinc and/or aluminum. The light-absorbing layer can be obtained as a layer having a good black appearance or a high adhesion by performing a single stage process at a relatively low temperature in an electroless manner for a short time as an economical surface process on the surface containing zinc and/or aluminum. In addition, the light-absorbing layer included in the light-absorbing member according to the present invention may be manufactured by using an appropriately-selected composition without using expensive silver, a noxious water-soluble antimony compound, and an agent having a malodor of ammonia. Accordingly, the present invention can be advantageously utilized for home electric appliances, parts of optical apparatuses, parts of transport equipment, parts of electronic apparatuses, building materials, zinc die cast products, or zinc coating material for kitchenware, aluminum materials, a heat ray absorbing material, a reflection preventing material, and the like.

### BRIEF DESCRIPTION OF THE DRAWINGS

FIGS. 1(A) and 1(B) are views illustrating results of analysis of a film according to Embodiment 1.

FIGS. 2(A) and 2(B) are views illustrating results of analysis of a film according to Embodiment 1.

FIG. 3 is a view illustrating results of analysis of a film according to Embodiment 1.

### DETAILED DESCRIPTION OF THE INVENTION

In the present invention, with respect to a surface structure of a coated film, a black lower layer containing nickel and/or cobalt needs to be formed on a surface of a to-be-processed substrate having a surface containing zinc and/or aluminum, and a layer containing an oxide of at least one selected from aluminum, magnesium, and zinc needs to be formed as an upper layer thereof. A thickness of the upper layer is not particularly limited, but it is preferably in a range of 0.01 to 0.5 μm, more preferably, in a range of 0.05 to 0.5 μm in order to obtain an excellent reflection preventing function. In addition, a thickness of the lower thickness is in a range of 0.1 to 5 μm in order to obtain a sufficient black tone. If both of the upper layer and the lower layer have the thickness in the preferred ranges, the L value after the process according to the present invention is less than 20, so that the preferred light absorption is in a very good range.

If zinc and/or aluminum do not exist on the surface of the to-be-processed substrate, it is difficult to form the black layer containing nickel and/or cobalt with good adhesion, which is not preferable. As a preferred composition of the surface of the to-be-processed substrate (composition of the materials constituting the surface), zinc or aluminum is 50 wt % or more, or a sum of zinc and aluminum is 50 wt % or more. As the materials for the to-be-processed substrate, an aluminum series material, an alloy of aluminum and other metals such as an aluminum-magnesium alloy, an aluminum-copper alloy, an aluminum-silicon alloy, or aluminum-silicon-copper alloy, a zinc series alloy, and the like may be exemplified. As the aluminum series material for the preferred substrate, pure aluminum and JIS 1000 series are most preferable, and 2000 series, 3000 series, 5000 series, 6000 series, 7000 series, AC material, and ADC material are preferable. More preferably, these materials are used after a zinc substitution plating process, where the zinc includes sodium zincate, potassium zincate, and zinc fluoride is performed in advance. However, although the zinc substitution plating process is performed in advance, it is possible to implement the present invention. With respect to an alloy containing magnesium, although the zinc substitution plating process is performed in advance, it is also possible to implement the present invention. A process of forming a zinc layer may be performed in advance by performing the zinc substitution process on the surface of the to-be-processed substrate containing the alloy containing magnesium. In addition, as a zinc series alloy material, a ZDC material is preferable; and as a zinc coated steel material, a hot-dip galvanized steel, an electro-galvanized steel, a vacuum deposition galvanized steel, Zn—Al alloy plated steel, or the like is preferable. Although these materials are in a form of mixture, the materials can be simultaneously processed.

In addition, nickel and/or cobalt need to be contained in the lower layer formed on the surface of the to-be-processed substrate, and more preferably, both of the nickel and cobalt are contained. It is preferable that at least a portion of the nickel and/or cobalt is a sulfide in terms of black chromaticity. In addition, at least one of metal nano particles, oxides, and hydroxides of nickel or cobalt, and zinc compounds (as impurities) may be further included in the lower layer. In addition, in the outmost surface of the light-absorbing member according to the invention, an upper layer containing an oxide of at least one selected from aluminum, magnesium, and zinc is needed. The upper layer that has transparency is formed as a layer having an effect of trapping incident light. Therefore, the upper layer can improve a reflection preventing function of the back layer in the lower layer and improve abrasion resistance or adhesion of the coated film, so that the detachment of the black layer can be prevented. For example, the upper layer may be made of one of aluminum oxide, magnesium oxide, and zinc oxide or a mixture of two or more thereof. It is preferable that a separate one or a mixture of two or more of these oxides is substantially 50 wt % or more (including the case of 100 wt %) of a total amount of components of the coated film. In addition, it is particularly preferable that zinc oxide is included in the upper layer in terms of prevention of electrical charging or improvement of UV ray absorption effect. In the double layered structure of the coated film according to the present invention, the upper layer and the lower layer do not need to be clearly separated. In addition, a gradient composition structure where the composition is gradually varied in a depth direction may also be employer.

A method of producing a light-absorbing member according to the present invention needs to be any one of a first method, in which a to-be-processed substrate having a to-be-processed surface containing zinc and/or aluminum is allowed to be in contact with an aqueous solution containing nickel ions and/or cobalt ions, a water-soluble sulfur-containing compound, and acidic anions, so that a black lower layer containing nickel and/or cobalt is formed on the to-be-processed surface, and after that, an upper layer containing an oxide of at least one selected from aluminum, magnesium, and zinc is formed on the lower layer, and a second method, in which the to-be-processed substrate having the to-be-processed surface containing zinc and/or aluminum is allowed to be in contact with an aqueous solution containing nickel ions and/or cobalt ions, zinc ions, a water-soluble sulfur-containing compound, and acidic anions, so that the black lower layer containing nickel and/or cobalt and the upper layer containing an oxide of at least one selected from aluminum, magnesium, and zinc are simultaneously formed.

In the present invention, as a process solution for forming a black lower layer, an aqueous solution including nickel ions and/or cobalt ions, a water-soluble sulfur-containing compound, and acidic anions may be used. In addition, a compound of at least one metal selected from aluminum, magnesium, and zinc is included in the process solution, subsequently to the generation of the black layer, a substantially transparent oxide of aluminum, magnesium, or zinc is precipitated thereon, so that the lower layer and the upper layer can be simultaneously formed by one-time process.

The nickel ions and cobalt ions in the process solution may be added in a form of a sulfate, a nitrate, a chloride, a fluoride, a carbonate, an acetate, an oxalate, a hydroxide, an oxide, and the like. Particularly, the sulfate, the chloride, the carbonate (basic carbonate), and the hydroxide are preferable. In the case where these ions are added, different kinds of salts may be added, but it is preferable that the same kind of salts is added. In addition, in the case where nickel ions or cobalt ions are separately included, it is preferable that copper ions or noble metal ions are less than 20 wt % with respect to any one of amounts of the nickel ions and the cobalt ions in terms of a decrease in reflectance. In the case where both of the nickel ions and the cobalt ions are included, it is preferable that the copper ions or noble metal ions are less than 20 wt % with respect to a summed amount of the nickel ions and cobalt ions in terms of a decrease in reflectance.

The water-soluble sulfur-containing compound that can form a sulfide of nickel and/or cobalt is used, but the present invention is not limited thereto. As the water-soluble sulfur-containing compound, phenyl thiourea, acetyl thiourea, allyl thiourea, thiourea dioxide, thiosulfuric acid, thiophosphoric acid, thiocyanic acid, thioglycolic acid, dithioglycol, alkyl thiourea, thiourea, thiocarbamic acid, thiosemi-carbazide, carbo-dithioate, thiocarbo-hydrazide, and derivatives thereof, that is, the sulfur-containing compounds having water solubility may be used. As the sulfur-containing compound, it is preferable that a C═S bond and a —NH₂ group are included in a molecular structure in terms of black chromaticity and stability of the process solution, and thiourea dioxide, thiourea, and derivatives thereof are most preferable. As a preferred derivative, there are alkyl thiourea having carbon number of 3 to 9, acetyl thiourea, allylthiourea, and phenylthiourea. These thioureas may be used separately or in a mixture of two or more thereof. As the acidic anions, any one of organic and inorganic acidic anions may be used, but sulfate ions, nitrate ions, chloride ions, fluoride ions, and carboxylate ions are preferable. When nickel or cobalt ions are supplied, sulfate, nitrate, chloride, acetate, oxalate, or the like is added, so that the aforementioned ions may be supplied at the same time of supplying the nickel or cobalt ions. The pH of the process solution is not particularly limited, but preferably, 7 or less, more preferably, in a range of 2 to 6.

In the case where the to-be-processed surface of the to-be-processed substrate is made of aluminum or an alloy thereof, it is preferable that the process solution includes fluoride ions as the acidic anions. If the fluoride ions exist, although the aluminum material is directly processed without performing a zinc substitution process, a good appearance can be obtained. When nickel or cobalt ions are supplied, a sulfate, nitrate, a chloride, an acetate, or an oxalate may be added, so that the aforementioned ions can be supplied at the same time of supplying the nickel or cobalt ions.

The pH of the process solution is not particularly limited, but preferably 7 or less, more preferably, in a range of 2 to 6.

In the process solution according to the present invention, in the case where the nickel ions or the cobalt ions are separately included as metal ions for forming sulfide, it is preferable that the sulfur-containing compound is 1 weight % or more with respect to any one of amounts of the nickel ions and the cobalt ions. In the case where both of the nickel ions and the cobalt ions are included, it is preferable that the sulfur-containing compound is 1 weight % or more with respect to a summed amount of the nickel ions and the cobalt ions. With respect to 10 weight % of the metal ions, although the amount of the sulfur-containing compound exceeds 50 weight %, the performance of the black appearance is not changed. However, if the amount exceeds 50 weight %, sedimentation easily occurs. Therefore, it is preferable that the amount of the sulfur-containing compound is less than 50 weight %. In the case where both of the nickel and cobalt are used for the metal ions, among the total 10 weight % of the metal ions, it is preferable that the nickel ions are in a range of 2 to 9 weight % and the remaining materials are the cobalt ions. If the amount of the nickel ions is less than 2 weight %, black may not sufficiently obtained according to a kind of material. In addition, if the amount of the nickel ions is more than 9 weight %, the black may not also be obtained. The concentration of the case where the nickel ions or the cobalt ions are separately included in the process solution or the concentration of the case where both of the nickel ions and the cobalt ions are included is preferably in a range of 1 to 50 g/L, and more preferably, in a range of 2 to 30 g/L. A process temperature is preferably in a range of 20 to 50° C., and a process time is preferably in a range of 5 to 180 seconds.

The aforementioned compounds for producing the process solution are dissolved into water so as to produce the process solution. However, the process solution may include solvents other than the water within a range where the effect is not impaired. In this case, a solvent compatible with water, for example, an alcohol series solvent may be selected. The concentration of the process solution is not particularly limited within a concentration range where an added compound can be dissolved. However, it is preferable that the concentration is in a range of 3 to 200 g/L as the metal ions. If less than 3 g/L, a long time is needed for the process; and if more than 200 g/L, some non-dissolved salts may be precipitated. It is preferable that at least one of aluminum, magnesium, and zinc is added to the process solution. It is more preferable that the concentration of the case where the aluminum, the magnesium, or the zinc is separately used or the summed concentration of the case where two or more of the aluminum, the magnesium, and the zinc are used is in a range of 0.05 to 20 g/L.

In addition, it is preferable that the concentration ratio (A)/(B) of the concentration (A gIL) of zinc in the aqueous solution to the concentration of the case where the nickel ions or the cobalt ions are separately used or the summed concentration (B gIL) of the case where both of the nickel ions and the cobalt ions are used is in a range of 0.05 to 1.0. In the composition range, it is particularly preferable that the acidic anions, preferably, fluoride ions are included. This is because, although the metal of the base layer includes aluminum as a main component but not including zinc, the light-absorbing coated film according to the present invention can be directly obtained without a pretreatment of forming a zinc layer on a surface through a zinc substitution process. The concentration ratio (A)/(B) is preferably in a range of 0.1 to 0.5.

The to-be-processed surface of the to-be-processed substrate that can be processed according to the method of the present invention is made of zinc, a zinc alloy, aluminum, or an aluminum alloy. The to-be-processed substrate includes, for example, a glass or resin material coated with aluminum or zinc through vacuum deposition or sputtering as well as a metal material having a surface made of a zinc and/or aluminum alloy such as a zinc and/or aluminum alloy plated steel, zinc and/or aluminum alloy plated aluminum, or a zinc or aluminum die cast.

When the to-be-processed surface containing zinc and/or aluminum is in contact with the process solution, zinc is eluted from the to-be-processed surface. In addition, although nickel ions and cobalt ions in the solution are precipitated as superfine particles on the surface of the material through the substitution reaction, in this case, some portion of the ions are combined with sulfur elements that are generated by decomposing the sulfur-containing compound through the surface reaction, so that sulfide is partially generated. Remaining metal ions are precipitated in a form of fine particles or oxides, so that a black film is formed. In this case, if ions or oxides of aluminum, magnesium, zinc, or the like exist in the solution, the oxides of aluminum, magnesium, or zinc are precipitated and deposited on the black layer as a sediment according to the increase in pH at the interface, so that a black tone suitable for the black layer can be obtained in order to prevent the black layer from be dissolved again. After the process is ended, the resulting product is water-rinsed and dried, so that the upper layer containing at least one oxide selected from the precipitated aluminum, magnesium, and zinc becomes a protective film for the black layer. Therefore, the adhesion and durability of the black layer are improved. In addition, the upper layer becomes a reflection-preventing layer, so that the performance of the light absorption is also improved. In the case where ions of at least one of aluminum, magnesium, and zinc do not exist, since a transparent oxide layer cannot be easily generated, it is preferable that, after the blackening process, the upper layer containing at least one oxide of aluminum, magnesium, and zinc are formed by coating an oxide sal of aluminum, magnesium, or zinc or a precursor solution obtained by dissolving these metals and baking the resulting product. As a component of the precursor solution, oxalate, maleate, nitrate, chloride, sulfate, β-diketone complex, or the like of aluminum, magnesium, or zinc is preferable. In addition, it is also preferable that, after the blackening process, the upper layer is formed by precipitating zinc hydroxide by allowing the resulting product to be in contact with an acidic solution containing the aluminum, magnesium, or zinc and by water-rinsing and drying the resulting product.

When the present invention is performed, as a method of allowing the to-be-processed surface of the to-be-processed substrate to be in contact with the process solution, a method of immersing the to-be-processed substrate into the process solution or coating the process solution on the to-be-processed surface of the to-be-processed substrate through spray or the like may be adapted. In addition, an electrolysis process using a metal material member as a cathode may be used.

The process temperature is not particularly limited, but it is preferably in a range of 0 to 80° C., more preferably, in a range of 20 to 50° C. The process time cannot be defined simply by the concentration of the process solution, the processing method, the process temperature, and the like. However, in general, for several seconds to several minutes, the metal material member is allowed to be in contact with the process solution. If the process time is too long, a shape of the surface of the material may be deformed. In addition, it is preferable that, after the process, the process solution is removed rapidly by performing water-rinsing, or the like. In addition, it is preferable that, before the material is in contact with the process solution, a pretreatment such as degreasing is performed according to conventional methods.

In the present invention, the interface between the upper layer and the lower layer is formed as a clear interface where the composition is varied. In addition, the interface may be formed as an interface where the composition of the lower layer is continuously or discontinuously varied toward the upper layer.

### EXAMPLES

Hereinafter, examples of the present invention and comparative examples are described. The present invention is not limited to the scope represented by the examples.

Test Plate: As the test plate, two zinc coated aluminum plates, of which the surface is coated with metal zinc, were used. The zinc coated aluminum plate was obtained by degreasing a pure aluminum plate (thickness: 1 mm and area: 50×100 mm) using an alkaline degreasing agent (FC-315, manufactured by Nihon Parkerizing Co., Ltd.), by water-rinsing, by drying, and by processing the resulting product in a zinc substitution plating bath, which was prepared by dissolving zinc oxide in sodium hydroxide, for 30 seconds.

Processes: (Embodiments 1 to 5, Embodiments 9 to 11, Comparative Examples 1 to 3)

The process solution having a composition shown in Table 1 was prepared (by using pure water as a solvent). The prepared blackening process solution was heated at 50° C., and the test plate was immersed into the solution for 120 seconds, so that the upper layer and the lower layer were simultaneously formed on the surface. After the process, water rinsing was performed, and drying was performed at 150° C. for 5 minutes. As the test plate, in Embodiments 2, 4, and 9 to 11 and Comparative Example 3, a pure aluminum plate was used; and in Embodiments 1, 3, and 5 and Comparative Examples 1 and 2, a zinc coated aluminum plate was used. The acidic anions were counter ions of nickel and cobalt. As the acidic anions shown in Table 1, mainly a sulfate, a chloride, an acetate, and the like of nickel or cobalt were added in a range of 50 to 200 g/L. In Embodiments 2, 4, and 9 to 11 and Comparative Example 3, where fluoride ions were included, acidic ammonium fluoride of 1 g/L was added. As the water-soluble sulfur-containing compound,

A: thiourea (Embodiments 1, 4, and 10, and Comparative Example 1),

B: N-phenyl thiourea (Embodiments 2 and 11), and

C: thiourea dioxide (Embodiments 3 and 5 and Comparative Example 3)

were used. The pH of the solution was adjusted by using a diluted sulfuric acid or ammonia water so that the pH is in a range of 3 to 5. With respect to the addition levels of the zinc, the aluminum, and the magnesium, these metal salts were added as the salts of the same kind as nickel or cobalt (for example, zinc sulfate was added in Embodiment 1 using nickel sulfate). In addition, in Embodiment 9, copper sulfate (II) of 0.2 g/L was further added. In Embodiment 10, silver sulfate of 0.1 g/L was added.

### Embodiment 6

A process plate that was prepared by a bath composition excluding Al from the composition of the process solution of Embodiment 5 was coated with 10 g/L of a zinc oxalate solution so that a thickness of the layer was 0.2 μm after the drying. The process plate was dried at 300° C. As a result, a test plate was produced.

### Embodiment 7

A process plate that was prepared in the same condition as that of Embodiment 6 was coated with 10 g/L of an alumina sol so that a thickness of the layer was 0.5 μm after the drying. The process plate was dried at 150° C. As a result, a test plate was produced.

### Embodiment 8

A process plate that was prepared in the same condition as that of Embodiment 6 was immersed in 20 g/L of a magnesium nitrate aqueous solution at 50° C. for 120 seconds, and after water rinsing, the process plate was dried at 200° C. for one hour, so that an upper layer of magnesium oxide was formed on the surface thereof. As a result, a test plate was produced.

### Comparative Example 4

A process plate that was prepared in the same condition as that of Comparative Example 1 was immersed in 10 g/L of a silica sol (Snow Tex N manufactured by Nissan Chemical Industries Co., Ltd.) for 20 seconds, and the process plate was dried at 150° C. for one hour, so that an upper layer of silicon oxide was formed on the surface thereof. As a result, a test plate was produced.

TABLE 1
Composition of Process Solution

| | Ni | Co | Sulfur | | | |
|---|---|---|---|---|---|---|
| | ion | ion | Com- | | Al, Mg, Zn, | A/ |
| Level | (g/L) | (g/L) | pound | Anion | Cu, Ag (g/L) | B |
| Embodiment 1 | 10 | — | A | SO₄²⁻ | Zn: 1 | 0.1 |
| Embodiment 2 | 10 | 20 | B | F⁻ | Mg: 5 | 0 |
| Embodiment 3 | 2 | 4 | C | acetic | Al: 1 | 0 |
| | | | | acid | | |
| Embodiment 4 | — | 6 | A | F⁻ | Mg: 5 | 0 |
| Embodiment 5 | 10 | 5 | C | SO₄²⁻ | Al: 0.5 | 0 |
| Embodiment 6 | 10 | 5 | C | SO₄²⁻ | — | 0 |
| Embodiment 7 | 10 | 5 | C | SO₄²⁻ | — | 0 |
| Embodiment 8 | 10 | 5 | C | SO₄²⁻ | — | 0 |
| Embodiment 9 | 10 | 0 | C | F⁻ | Zn: 5 | 0.5 |
| | | | | | Cu: 0.2 | |
| | | | | | (copper | |
| | | | | | sulfate (II)) | |
| Embodiment 10 | 20 | 0 | A | F⁻ | Zn: 5 | 0.25 |
| | | | | | Ag: 0.1 | |
| | | | | | (silver | |
| | | | | | sulfate) | |
| Embodiment 11 | 28 | 2 | B | F⁻ | Zn: 2 | 0.07 |
| Comparative | 10 | 5 | A | SO₄²⁻ | — | 0 |
| Example 1 | | | | | | |
| Comparative | 10 | 8 | — | Cl⁻ | Al: 1 | 0 |
| Example 2 | | | | | | |
| Comparative | 10 | — | C | F⁻ | — | 0 |
| Example 3 | | | | | | |
| Comparative | 10 | 5 | A | SO₄²⁻- | — | 0 |
| Example 4 | | | | | | |

The following performance evaluation on the obtained test material was performed. Results of the estimation were listed in Table 2.

1) Light Absorption: The L value of the surface of the test material was measured and evaluated as an index of performance of the light absorption by a color-difference meter (Color Meter, manufactured by Nippon Denshoku Industries Co., Ltd.) (The smaller the L value is, the better the light absorption is).

2) Abrasion Resistance: The surface of the test material was reciprocally abraded by white paper (KIM-WYPE) 20 times, and after detached, an amount of a black film attached on the paper was visually determined.

A: case where attachment is not recognized

B: case where there is slight attachment

C: case where the paper is blackened

TABLE 2
Result of Evaluation Test

| | Light Absorption | Abrasion |
|---|---|---|
| | (L Value) | Resistance |
| Embodiment 1 | 14 | A |
| Embodiment 2 | 15 | A |
| Embodiment 3 | 16 | A |
| Embodiment 4 | 14 | A |
| Embodiment 5 | 13 | A |
| Embodiment 6 | 12 | A |
| Embodiment 7 | 11 | A |
| Embodiment 8 | 11 | A |
| Embodiment 9 | 11 | A |
| Embodiment 10 | 8 | A |
| Embodiment 11 | 9 | A |
| Comparative Example 1 | 24 | C |
| Comparative Example 2 | 21 | C |
| Comparative Example 3 | 28 | B |
| Comparative Example 4 | 21 | B |

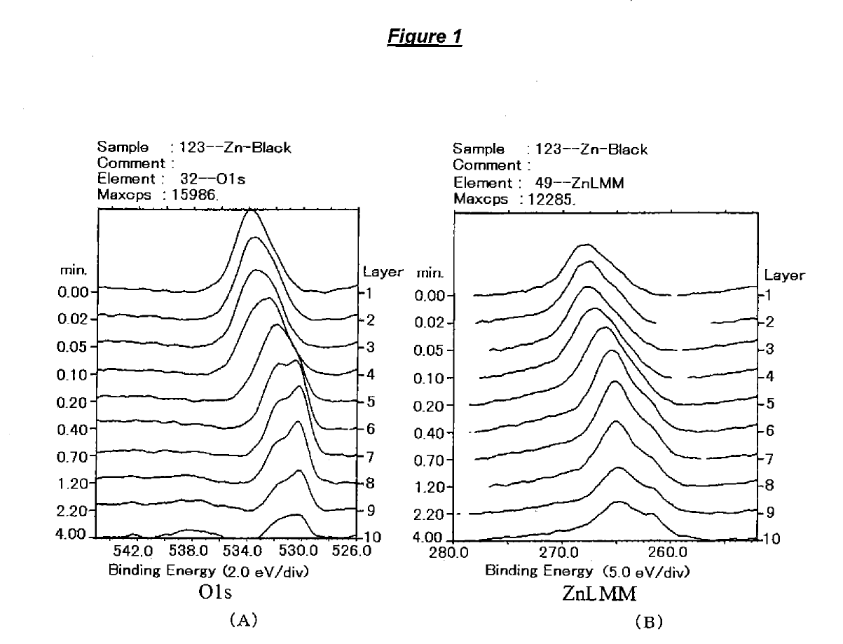

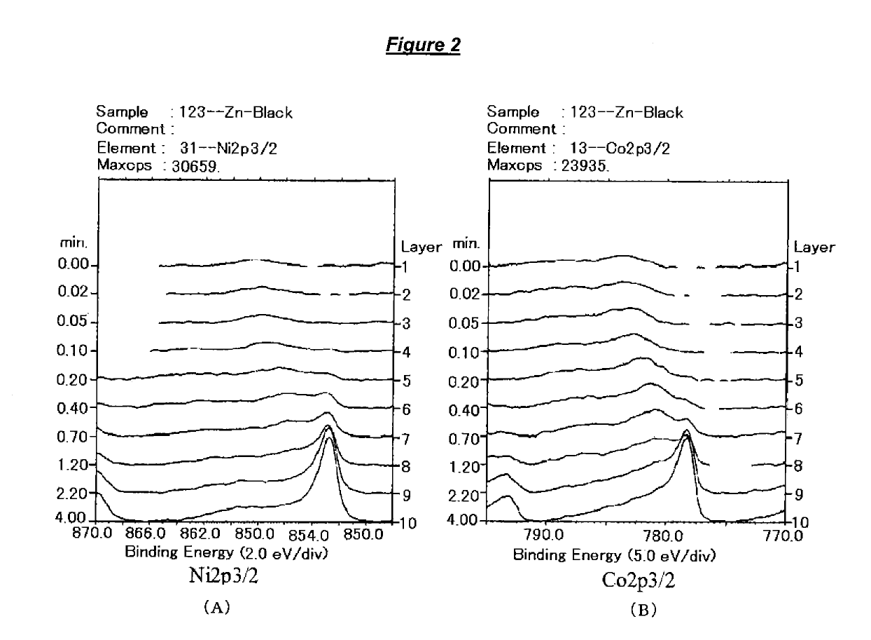

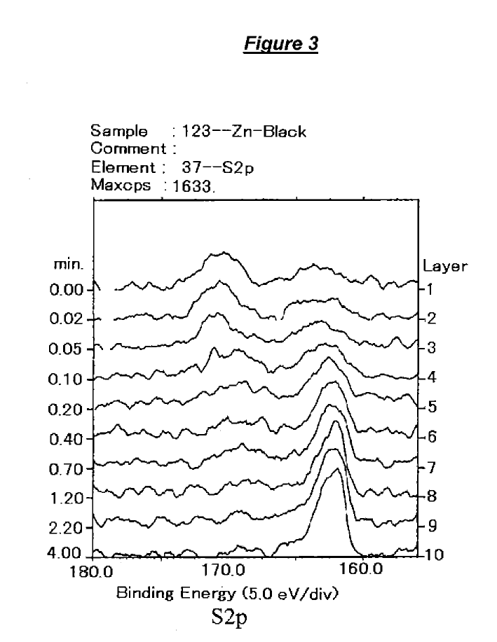

In addition, in order to check that the coated films of the embodiments were constructed with the upper layer and the lower layer having different compositions, the surfaces of the coated films of the embodiments and the comparative examples were analyzed by using XPS. As a result, it was checked that each coated film generated according to each embodiment was constructed with the upper layer having a thickness of 0.01 to 0.3 μm and the lower layer having a thickness of 0.1 to 1 μm. The result of analysis of the coated film according to Embodiment 1 is illustrated as a representative example in FIGS. 1 to 3. It can be understood that the coated film is constructed with an upper layer containing zinc oxide and a lower layer containing sulfide of nickel and/or Co.

As clarified and understood from the above evaluation and test results, in terms of the performance of the embodiments of the invention, excellent light absorption, excellent abrasion resistance, and excellent practicability can be obtained.

What is claimed is:

1. A light-absorbing member comprising:
a substrate having a surface containing zinc and/or aluminum;
a black lower layer containing nickel and/or cobalt attached to said surface; and
an upper layer on the black lower layer, said upper layer containing an oxide of aluminum, magnesium, and/or zinc.

2. A method of producing the light-absorbing member according to claim 1, comprising steps of:
a) contacting a to-be-processed substrate having the surface containing zinc and/or aluminum with an aqueous solution containing nickel ions and/or cobalt ions, a water-soluble sulfur-containing compound, and acidic anions, such that the black lower layer containing nickel and/or cobalt is formed on the surface, and
b) forming the upper layer after step a).

3. A method of producing the light-absorbing member according to claim 1, comprising steps of
contacting a to-be-processed substrate having the surface containing zinc and/or aluminum with an aqueous solution containing:
at least one element selected from aluminum, magnesium, and zinc;
nickel ions and/or cobalt ions;
a water-soluble sulfur-containing compound; and
acidic anions;
such that the black lower layer containing nickel and/or cobalt and the upper layer containing an oxide of aluminum, magnesium, and/or zinc are simultaneously formed on said surface.

4. The method according to claim 2 wherein the acidic anions include at least fluoride ions.

5. The method according to claim 2 wherein the water-soluble sulfur-containing compound has a molecular structure comprising a C═S bond and a —NH₂ group.

6. The method according to claim 2 wherein the water-soluble sulfur-containing compound is at least one compound selected from the group consisting of thiourea dioxide, thiourea, and derivatives thereof.

7. The method according to claim 2 wherein a concentration ratio (A)/(B) of a concentration (A) in g/L of zinc to a concentration (B) in g/L of nickel ions and/or cobalt ions in the aqueous solution is in a range of from 0.05 to 1.0.

8. The method according to claim 2 wherein the surface of the to-be-processed substrate comprises 50 wt % or more zinc, aluminum or a combination thereof and the aqueous solution is free of silver and antimony.

9. The method according to claim 3 wherein a concentration ratio (A)/(B) of a concentration (A) in g/L of zinc to a concentration (B) in g/L of nickel ions and/or cobalt ions in the aqueous solution is in a range of from 0.05 to 1.0.

10. The method according to claim 3 wherein the acidic anions include at least fluoride ions.

11. The method according to claim 3 wherein the water-soluble sulfur-containing compound has a molecular structure comprising a C═S bond and a —NH₂ group.

12. The method according to claim 3 wherein the water-soluble sulfur-containing compound is at least one compound selected from the group consisting of thiourea dioxide, thiourea, and derivatives thereof.

13. The light-absorbing member according to claim 1 wherein at least a portion of the nickel and/or cobalt in the black lower layer is present as part of one or more sulfide compounds.

14. The light-absorbing member according to claim 1 wherein the lower layer comprises at least one of metal nanoparticles, oxides of nickel or cobalt, hydroxides of nickel or cobalt, and zinc compounds.
